(19) United States
(12) Patent Application Publication
(10) Pub. No.: US 2005/0224511 A1
(43) Pub. Date: Oct. 13, 2005

(54) Tablet dispensing apparatus for tablet automatic packing machine

(75) Inventor: Jun-ho Kim, Dalseo-Gu (KR)

Correspondence Address: OBLON, SPIVAK, MCCLELLAND, MAIER & NEUSTADT, P.C., 1940 DUKE STREET, ALEXANDRIA, VA, 22314, US

(73) Assignee: JVM CO., LTD., Dalseo-Gu (KR)

(21) Appl. No.: 10/974,825

(22) Filed: Oct. 28, 2004

(30) Foreign Application Priority Data
Apr. 13, 2004 (KR) 10-2004-25471

(51) Int. Cl. B65H 5/28; G07F 11/68; G07F 11/00

(52) U.S. Cl. 221/84; 221/71

(57) ABSTRACT

A tablet dispensing apparatus capable of easily performing tablet dispensing controls and of stably performing open/close operation of opening/closing levers is disclosed, in which it is simply constructed and its initial settings for dispensing tablets is easily set. The tablet dispensing apparatus, in which a pair of plates forms a frame, tablet dispensing means is provided at one end portion of the frame, tray opening means is provided at the other end portion of the frame, and a conveyor belt having a plurality of tablet reception feeders wounded in a pair of rotation shafts, wherein the tablet dispensing means comprises a hinge shaft installed to the one end of the frame, a plurality of opening/closing levers each of which has a tablet receiver thereunder, the plurality of opening/closing levers are rotatably installed to the hinge shaft, facing the plurality of tablet reception feeders, a plurality of partitions installed between the opening/closing levers and a plurality of solenoids connected to external surfaces of the plurality of opening/closing levers by operation rods, respectively, for performing opening/closing operation of the opening/closing levers according to the control of power supplied to the plurality of solenoids.

### BACKGROUND OF THE INVENTION

1. Field of the Invention

The present invention relates to a tablet dispensing apparatus for a tablet automatic packing machine, and more particularly to a tablet dispensing apparatus capable of easily performing tablet dispensing controls and of stably performing open/close operation of opening/closing levers, in which the structure of the tablet dispensing apparatus is simply constructed and its initial settings for dispensing tablets is easily set.

2. Description of the Related Art

Generally, tablet automatic packing machines serve to receive tablets from tablet cassettes through a tablet dispensing device based on kinds of tablets and to successively pack the dispensed tablets in pouches based on dosage units.

With reference to FIG. 1, a prior art tablet automatic packing machine is described in detail in terms of its structure and operations.

The prior art tablet automatic packing machine includes a plurality of tablet cassettes 100 on a shelf located a predetermined height from the bottom, a tablet dispensing apparatus 200 installed under the self, a hopper installed under the plurality of tablet cassettes 100 and the tablet dispensing apparatus 200, a printing unit 400 for printing information on each pouch for the tablets, and a sealing unit 500 for sealing the pouch on which the information is printed.

In operations of the prior art tablet automatic packing machine, tablets are dispensed from the tablet cassettes 100 and the tablet dispensing apparatus 200 by a controlling unit to a hopper 300, based on dosage units according to prescription data. The collected tablets through the hopper based on dosage units are packaged by being sealed in a pouch by the sealing unit 500.

With reference to FIGS. 2 and 3, operations of the prior art tablet automatic packing machine are described in detail below.

The prior art tablet dispensing apparatus 200 includes a pair of plates forming a frame 201, tablet dispensing means 204 at one end portion of the frame 201, tray opening means 202 at the other end portion of the frame 201, and a conveyor belt 203 wounded in a pair of rotation shafts 232 installed to the one and other end portions of the frame 201, in which one of the rotation shafts 232 is driven by a first motor 231, and the conveyor belt 203 has a plurality of tablet reception feeders 233 attached to the outer surface thereof, which are space at even intervals. Each row of the plurality of the tablet reception feeders 233 has a plurality of tablet reception chambers.

Here, the tray opening means 202 operates as a second motor 211 installed to the other end portion of the frame 201 rotates a cam 212 connected to its rotation shaft to operate a hook 213 such that tablets corresponding to cells of a manual dispense tray T located over the tablet dispensing apparatus 200 are dropped to corresponding tablet reception chambers of the tablet reception feeders 233 at a time.

After that, the tablets contained in the corresponding tablet reception chambers are transported toward the tablet dispensing means 204 as the conveyor belt 203 continuously rotating with respect to the rotation shafts 232 by the first motor 231 transports the tablet reception feeders 233 row by row from the other end portion of the frame to the one end portion. Therefore, the transported tablets of the tablet reception feeders 233 are dispensed to the tablet dispensing means 204 row by row.

The tablets dispensed at a time from each row of the tablet reception feeders 233 are temporally blocked before being downwardly discharged therefrom by means of opening/closing levers 241 which are elastically operated by springs. The temporally blocked tablets dispended are downwardly discharged as each of discharging cams 244 aligned with 60° to the others is rotated by a third motor 242 with respect to a cam shaft 243 to operate each of the opening/closing levers 241. Here, the number of the opening/closing levers 241 is the same as that of the tablet reception chambers aligned in one row of the tablet reception feeders 233. Preferably, the number of opening/closing levers 241 is 6.

Although the discharging cams are operated to discharge the temporally blocked tablets by the third motor based on dosage units in a state in which they are aligned with a predetermined angle, the prior art tablet dispensing apparatus has disadvantages in that the discharging cams must be manually set to be aligned to each other with the same angle with respect to the cam shaft at an initial settings. For example, the discharging cams, for example, 6, must be manually aligned to the others with 60° with respect to the cam shaft at an initial settings.

Also, since the six discharging cams aligned to the cam shaft operate in association with each other as the third motor operates the rotation shaft connected thereto, the tablet dispensing means is configured to be mechanically complicated. Also, since the angle for the cams aligning with respect to the rotation shaft must be manually set, the precision of the operation of the tablet dispensing apparatus is relatively large decreased.

Therefore, since the precision of the tablet dispensing operations is low, the prior art tablet dispensing apparatus cannot easily control tablet dispensing, which serves to reduce the efficiency of the tablet automatic packing machine to relatively low level.

### SUMMARY OF THE INVENTION

Therefore, the present invention has been made in view of the above problems, and it is an object of the present invention to provide a tablet dispensing apparatus for a tablet automatic packing machine with a relatively simple structure capable of easily performing an initial settings for dispensing tablets and tablet dispensing controls and of stably performing open/close operation of opening/closing levers.

It is another object of the present invention to provide a tablet dispensing apparatus for a tablet automatic packing machine capable of enabling opening/closing levers to be relatively easily aligned and fixed corresponding to solenoids while the opening/closing levers are stably and elastically operated.

It is yet another object of the present invention to provide a tablet dispensing apparatus for a tablet automatic packing machine capable of being easily constructed as opening/closing levers are connected to operating rods of solenoids via link members, respectively, such that tablets dispensed from a plurality of tablet reception feeders are easily guided to the opening/closing levers.

In accordance with the present invention, the above and other objects can be accomplished by the provision of a tablet dispensing apparatus for a tablet automatic packing machine for dispensing tablets, in which a pair of plates forms a frame, tablet dispensing means is provided at one end portion of the frame, tray opening means is provided at the other end portion of the frame, and a conveyor belt wounded in a pair of rotation shafts installed to the one and the other end portions of the frame, in which one of the rotation shafts is driven by a first motor, and the conveyor belt has a plurality of tablet reception feeders attached to the outer surface thereof, which are evenly apart spaced from one another, wherein the tablet dispensing means comprises a hinge shaft installed to the one end of the frame, a plurality of opening/closing levers each of which has a tablet receiver thereunder, the plurality of opening/closing levers are rotatably installed to the hinge shaft, facing the plurality of tablet reception feeders, a plurality of partitions installed between the opening/closing levers and a plurality of solenoids connected to external surfaces of the plurality of opening/closing levers by operation rods, respectively, for performing opening/closing operation of the opening/closing levers according to the control of power supplied to the plurality of solenoids.

Preferably, the tablet dispensing apparatus may further comprise protrusions formed at upper ends of the opening/closing levers, respectively, a fixing bar installed between the frame under the protrusions and springs, both ends of which are connected to the protrusions and the fixing bar, respectively, such that the opening/closing levers are elastically operated.

Preferably, the tablet dispensing apparatus may further comprise a plurality of fixing plates installed between the frame to fix the plurality of solenoids thereon, respectively.

Preferably, the tablet dispensing apparatus may further comprise connection protrusions attached to the rear surfaces of the opening/closing levers, respectively, and link members hingably connecting between operation rods of the plurality of solenoids and the connection protrusions.

Preferably, the tablet dispensing apparatus may further comprise guide protrusions formed between the partitions to guide tablets discharged from the tablet reception feeders to tablet receivers of the opening/closing levers, in which the guiding protrusions are integratedly formed with the partitions.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a cross-sectional front view illustrating a prior art tablet automatic packing machine;

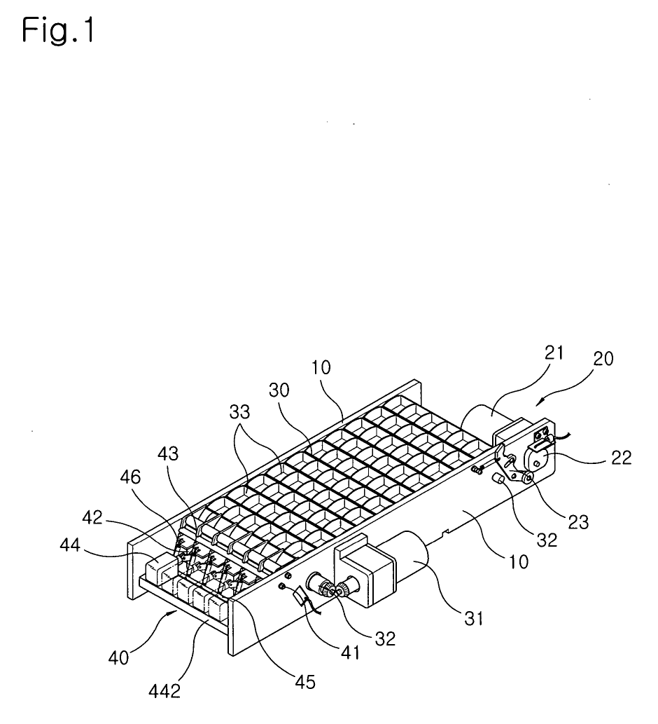

FIG. 2 is a perspective view illustrating a prior art tablet dispensing apparatus for a tablet automatic packing machine;

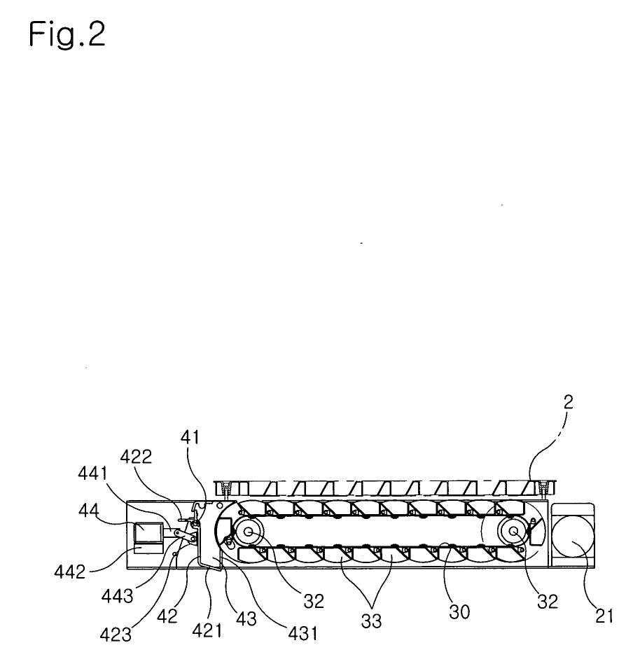

FIG. 3 is a partially enlarged cross-sectional side view of FIG. 2;

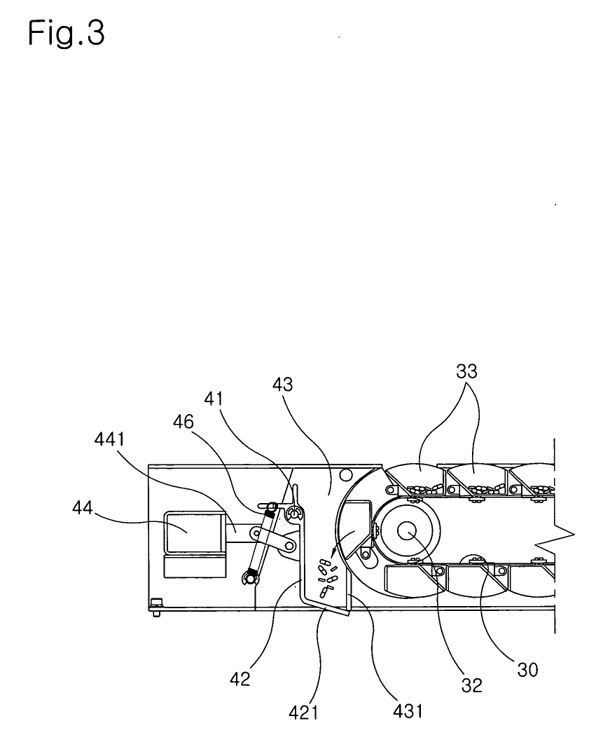

FIG. 4 is a perspective view illustrating a tablet dispensing apparatus for a tablet automatic packing machine according to the present invention;

FIG. 5 is a cross-sectional side view of FIG. 1;

FIG. 6 is a partially enlarged view illustrating a pre-operations state of a tablet dispensing apparatus for a tablet automatic packing machine according to the present invention; and

FIG. 7 is a partially enlarged view illustrating a post-operation state of a tablet dispensing apparatus for a tablet automatic packing machine according to the present invention.

### DESCRIPTION OF THE PREFERRED EMBODIMENTS

With reference to the attached drawings, the preferred embodiment of the present invention is described in detail below.

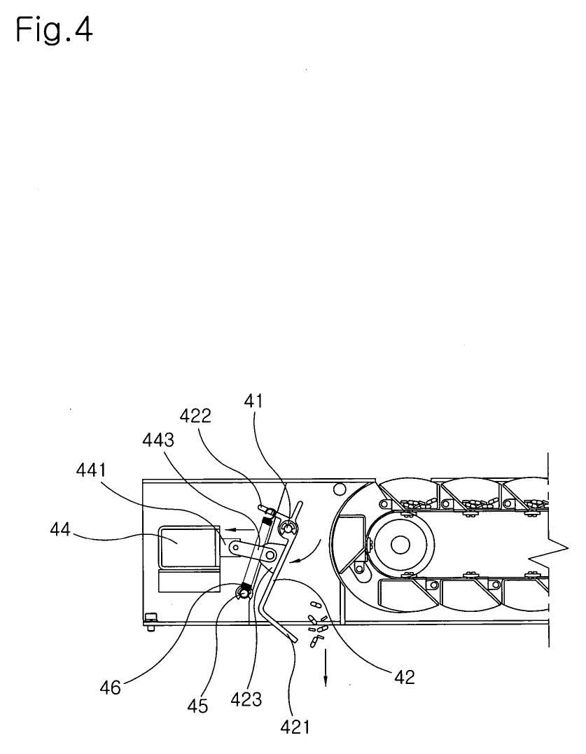

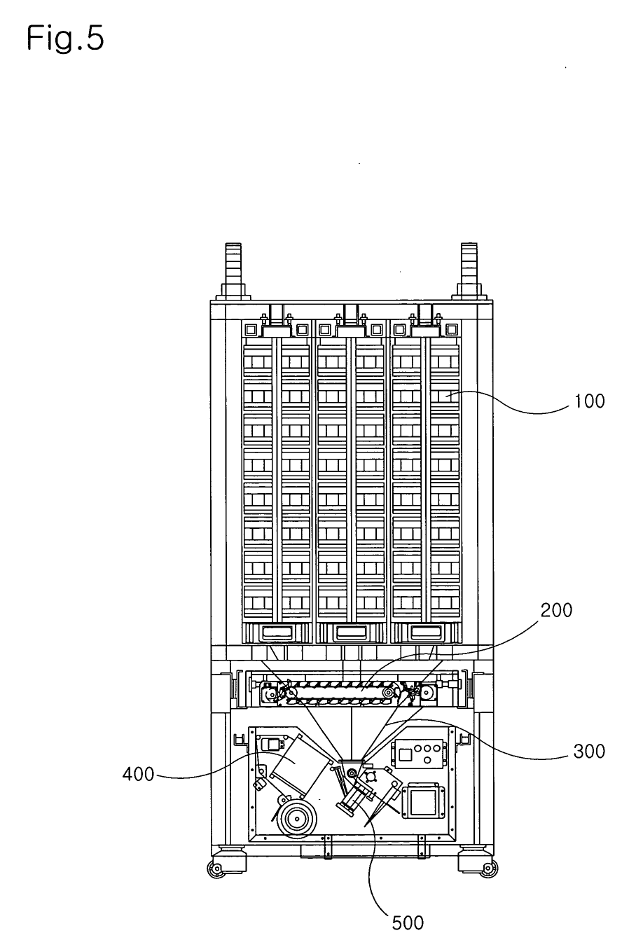

FIG. 4 is a perspective view illustrating a tablet dispensing apparatus for a tablet automatic packing machine according to the present invention, and FIG. 5 is a cross-sectional side view of FIG. 4.

As shown in FIGS. 4 and 5, the tablet dispensing apparatus according to the present invention includes a pair of plates forming a frame 10, tablet dispensing means 40 at one end portion of the frame 10, tray opening means 20 at the other end portion of the frame 10, and a conveyor belt 30 wounded in a pair of rotation shafts 32 installed between the two plates to the one and other end portions of the frame 10, in which one of the rotation shafts 32 is driven by a first motor 31 and the conveyor belt 30 has a plurality of tablet reception feeders 33 attached on the outer surface thereof.

The tray opening means 20 operates as a second motor 21 installed to the other end portion of frame 10 rotates a cam 22 connected to its rotation shaft to operate a hook 23 such that tablets cells of a manual dispense tray 2 located over the tablet dispensing apparatus are dropped to the tablet reception feeders 33 at a time.

The plurality of tablet reception feeders 33 attached on the outer surface of the conveyor belt 30 are evenly apart spaced from one another and row of the plurality of the tablet reception feeders 33 has a plurality of tablet reception chambers. Preferably, the number of chambers in each row of the tablet reception feeders is 6 in the embodiment of the present invention. The conveyor belt 30 operates to continuously rotate with respect to the rotation shafts 32 such that tablets contained in the tablet reception chambers of each row of the tablet reception feeders 33 are transported to the tablet dispensing means 40 as a first motor 31 rotates one of the rotation shafts 32.

The tablet dispensing means 40 includes a hinge shaft 41 installed at a corresponding end portion of the conveyor belt 30 to the one end portion of the frame 10, opening/closing levers 42 rotatably connected to the hinge shaft 41, in which the number of opening/closing levers 42 is preferably 6, partitions 43 formed between the opening/closing levers 42, and solenoids 44 each of which is correspondingly installed to each rear surface of the opening/closing levers 42 to operate the opening/closing levers 42.

Each of the opening/closing levers 42 is formed to include tablet receiver 421 bent to the lower end portion thereof, a protrusion 422 protruded to the upper end portion thereof and a connection protrusion 423 at the rear surface thereof.

Here, the tablet receiver 421 receives tablets discharged from each of the tablet reception feeders 33 such that the discharged tablets are placed in each of the opening/closing levers 42. The protrusions 422 of the respective opening/closing levers 42 are connected to a fixing bar 45 installed between the plates of the frame 10 by a spring 46, respectively, such that each of the opening/closing levers 42 can elastically operate its opening/closing operations.

Each of the connection protrusions 423 and each one end of the operation rods 441 of the solenoids 44 are hingably connected by a link member 443 at both ends of the link member 443 such that the link member 443 can easily connect each of the solenoids 44 to each of the opening/closing levers 42.

The partitions 43 block the sides between the opening/closing levers 42 to separate therebetween. Each of the guide protrusions 431 is formed to closely contact each end of the tablet receivers 421 between the partitions 43 such that the tablets discharged from each of the tablet reception feeders 33 can be easily guided to each of the tablet receivers 421. Here, the guiding protrusions are integratedly formed with the partitions.

In the preferred embodiment of the present invention, the solenoids 44 corresponding to the opening/closing levers 42 are implemented with 6 and installed to the fixing plates 442 placed in the one end of the frame 10, respectively. Each of the solenoids 44 includes an operation rod 441 which moves to and fro by a predetermined distance according to electromagnetic force generated therefrom as power is supplied thereto. The one end of the operation rods 441 is hingably connected to one end of the link members 443.

When power is supplied to each of the solenoids 44, each solenoid 44 pulls each of the link members 443. If the link member 443 is pulled, its corresponding opening/closing lever 42 hingably connected to the link member 443 is rotated with respect to the hinge shaft 41 with an angle corresponding to the linear displacement of the corresponding operation rod 441 such that the tablets contained in the corresponding tablet receiver 421 can be discharged therefrom.

The fixing plates 442 are installed such that the six solenoids 44 can be more easily arranged and fixed thereto, respectively.

Accordingly, even if the tablet dispensing apparatus according to the present invention as mentioned above is simply constructed, it can easily perform tablet dispensing controls as the six opening/closing levers 42 can individually perform an opening/closing operation based on each operation of solenoids 44.

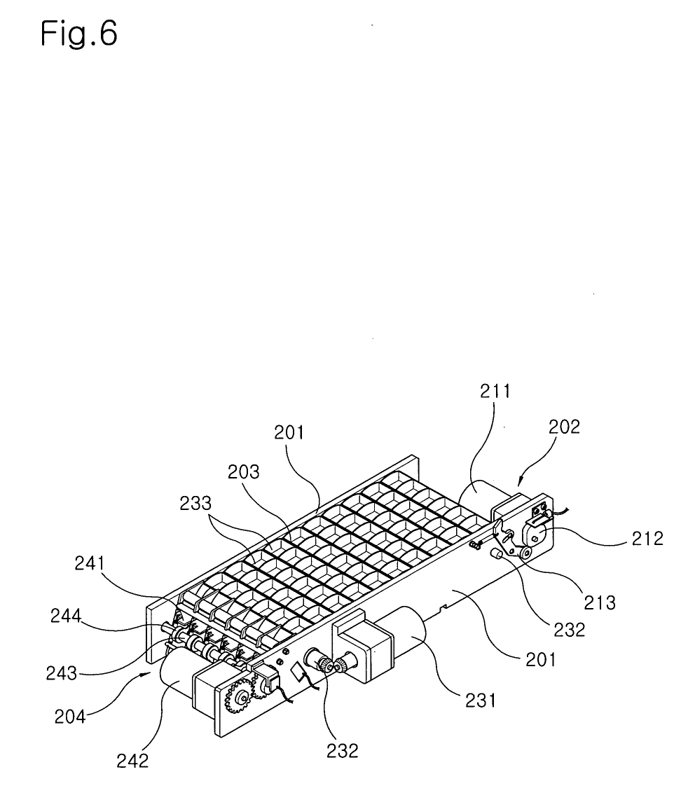

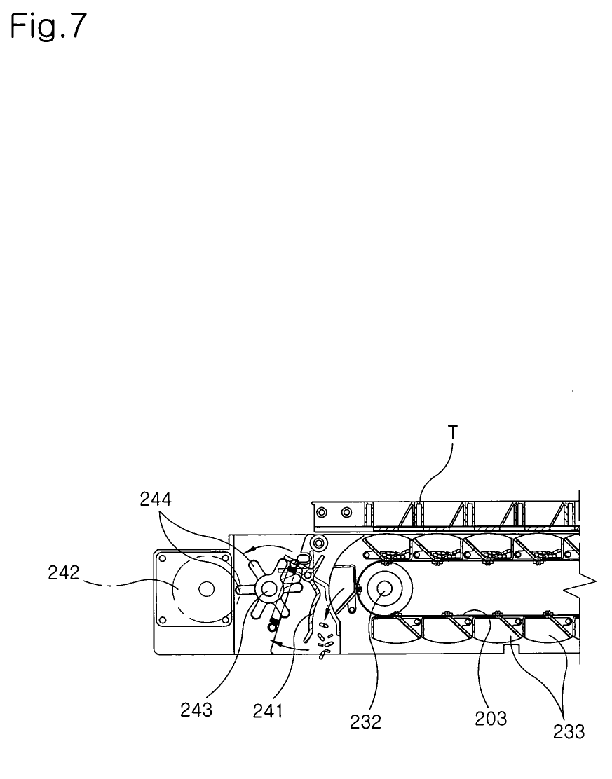

FIG. 6 is a partially enlarged view illustrating a pre-operations state of a tablet dispensing apparatus for a tablet automatic packing machine according to the present invention operates, and FIG. 7 is a partially enlarged view illustrating a post-operation state of a tablet dispensing apparatus for a tablet automatic packing machine according to the present invention.

As shown in FIG. 6, when the conveyor belt 30 rotates such that the tablet reception feeders 33 attached on the upper side thereof move from the other end to the one end by rotating the rotation shaft 32, the tablets contained the tablet reception feeders 33 are discharged to the tablet receivers 421 of the opening/closing levers 42 at the end portion of the conveyor belt 30 row by row.

Here, the transported tablets are more safely dropped from the tablet reception feeders 33 to the tablet receivers by the partitions 43 formed in the sides of the opening/closing levers and the guide protrusions 431 formed end of the tablet receivers 421 of the opening/closing levers 42.

As shown in FIG. 7, when power is supplied to each of the solenoids 44, each of the solenoids 44 pulls the operation rod 441. If the operation rod 441 is pulled, the opening/closing lever 42 hingably connected to the link member 443 through the connection protrusion 423 is rotated with respect to the hinge shaft 41 with an angle corresponding to the linear displacement of the operation rod 441 such that the tablets contained in the tablet receiver 421 can be downwardly discharged therefrom.

Here, each protrusion 422 of the opening/closing levers 42 and a fixing bar 45 are connected by each of the springs 46, such that each of the opening/closing levers 42 can be elastically operated by elasticity of each spring 46.

Meanwhile, when power supply to each of the solenoids 44 is cut off, each of the opening/closing levers 42 is returned to its initial position (or state) as shown in FIG. 6, as it rotates with respect to the hinge shaft 41 by the elasticity of the spring 46. Namely, each of the opening/closing levers 42 operates such that the tablet receiver 421 contacts the guide protrusion 431. Also, the operation rod 441 of each solenoid 444 is in an initial position (or state) in which it is protruded with a predetermined length from the solenoid.

As apparent from the above description, the tablet dispensing apparatus for tablet automatic packing machine according to the present invention can be relatively simply constructed, easily perform tablet dispensing controls and its initial settings such that the opening/closing levers can stably perform opening/closing operations to precisely dispense tablets. Also it can be easily installed and manufactured.

The tablet dispensing apparatus for the tablet automatic packing machine according to the present invention has advantages in that the solenoids are relatively easily arranged and fixed thereto while the opening/closing levers are stably and elastically located to their initial states. Also, it can be easily installed.

Also the tablet dispensing apparatus for tablet automatic packing machines according to the present invention has an advantage in that connection work of the solenoids can be easily performed as the opening/closing levers and the operation rods of the solenoids are connected hingably to each other by links and the tablets dispensed form the tablet reception feeders can be easily guided to the opening/closing levers. Also, the solenoids can be easily installed and the moving distance of the operation rods connected to the solenoids can be easily adjusted. Therefore the tablet dispensing apparatus according to the present invention can precisely collect the tablets so as to accurately package them into the pouches based on dosage units.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

1. A tablet dispensing apparatus for a tablet automatic packing machine for dispensing tablets, in which a pair of plates forms a frame, tablet dispensing means is provided at one end portion of the frame, tray opening means is provided at the other end portion of the frame, and a conveyor belt wounded in a pair of rotation shafts installed to the one and the other end portions of the frame, in which one of the rotation shafts is driven by a first motor, and the conveyor belt has a plurality of tablet reception feeders attached to the outer surface thereof, which are evenly apart spaced from one another,
wherein the tablet dispensing means comprises:
a hinge shaft installed to the one end of the frame;
a plurality of opening/closing levers each of which has a tablet receiver thereunder, the plurality of opening/closing levers are rotatably installed to the hinge shaft, facing the plurality of tablet reception feeders;
a plurality of partitions installed between the opening/closing levers; and
a plurality of solenoids connected to external surfaces of the plurality of opening/closing levers by operation rods, respectively, for performing opening/closing operation of the opening/closing levers according to the control of power supplied to the plurality of solenoids.

2. The tablet dispensing apparatus as set forth in claim 1, further comprising:
protrusions formed at upper ends of the opening/closing levers, respectively;
a fixing bar installed between the frame under the protrusions; and
springs, both ends of which are connected to the protrusions and the fixing bar, respectively, such that the opening/closing levers are elastically operated.

3. The tablet dispensing apparatus as set forth in claim 1 or 2, further comprising a plurality of fixing plates installed between the frame to fix the plurality of solenoids thereon, respectively.

4. The tablet dispensing apparatus as set forth in claim 3, further comprising:
connection protrusions attached to the rear surfaces of the opening/closing levers, respectively; and
link members hingably connecting between operation rods of the plurality of solenoids and the connection protrusions.

5. The tablet dispensing apparatus as set forth in claim 4, further comprising guide protrusions formed between the partitions to guide tablets discharged from the tablet reception feeders to tablet receivers of the opening/closing levers, in which the guiding protrusions are integratedly formed with the partitions.
